(19) United States
(12) Patent Application Publication
(10) Pub. No.: US 2019/0375353 A1
(43) Pub. Date: Dec. 12, 2019

(54) BATTERY UNIT AND METHOD FOR OPERATING A BATTERY UNIT

(71) Applicant: Robert Bosch GmbH, Stuttgart (DE)

(72) Inventors: Manuel Hohenauer, Beilstein (DE); Andreas Lemke, Berlin (DE); Bernd Heppner, Schwieberdingen (DE); Frank Stiegler, Affalterbach (DE); Henryk Weihs, Abstatt (DE); Jens Koerner, Bretzfeld-Scheppach (DE); Karl Kloess, Vaihingen (DE); Klaus-Juergen Schuler, Leingarten (DE); Matthias Gernsbeck, Karlsruhe-Gruenwettersbach (DE); Michael Steil, Korntal-Muenchingen (DE); Steffen Adolf, Asperg (DE)

(21) Appl. No.: 16/480,744

(22) PCT Filed: Jan. 12, 2018
(86) PCT No.: PCT/EP2018/050725

§ 371 Date: Jul. 25, 2019

(30) Foreign Application Priority Data
Jan. 26, 2017 (DE) 10 2017 201 241.2

(51) Int. Cl. B60R 16/033; H01M 10/42; H01M 10/0525

(52) U.S. Cl. CPC B60R 16/033; H01M 10/425; B60K 6/28; H01M 2220/20; H01M 2010/4271; H01M 10/0525

(57) ABSTRACT

The invention relates to a battery unit for use on an electrical system of a motor vehicle, comprising a battery module and a coupling unit (30). The coupling unit has a first and a second connection (31 and 32), a first and a second DC converter (41 and 42). The first DC converter (41) allows a bidirectional current flow between the connections (31, 32), the second DC converter (42) allows a current flow from the first connection (31) to the second connection (32). The battery unit comprises a control system. The control system controls the DC converter. The invention also relates to a method for operating the battery unit on a motor vehicle's electrical system. A coupling current (1k) flowing through the coupling unit (30) is measured. When the coupling current (1k) flows from the first connection (31) to the second connection (32) and falls short of a first threshold value, the second DC converter (42) is connected and the first DC converter (41) is disabled.

### BACKGROUND OF THE INVENTION

The invention relates to a battery unit for use in an electrical system of a motor vehicle, said battery unit comprising a battery module and a coupling unit for coupling the battery module to the electrical system and having a first connection connected to the battery module, a second connection that can be connected to the electrical system, a first DC voltage converter and a second DC voltage converter. The invention also relates to a method for operating a battery unit according to the invention in an electrical system of a motor vehicle.

Lead acid batteries are generally used as an energy store in a 12-V electrical system in conventional motor vehicles having an internal combustion engine. Such a lead acid battery, which has a positive pole and a negative pole, is used, inter alia, as a starter battery for starting the internal combustion engine. The electrical system and its functionalities are matched to the properties of the lead acid battery, for example internal resistance, charging/discharging characteristic curve and no-load voltage.

The important factor in this case is to correctly detect the state of the lead acid battery in the motor vehicle. The state, in particular the state of charge, of the lead acid battery is used by the motor vehicle as a basis for energy management functions and can therefore have a greatly negative effect on the vehicle behavior and the availability in the case of incorrect detection. Safety-relevant functionalities of the motor vehicle can also be affected thereby.

A battery sensor, which is connected to the lead acid battery, typically detects the state of the lead acid battery. In this case, the battery sensor measures, inter alia, a current flowing through the lead acid battery and a voltage applied to the poles of the lead acid battery and determines therefrom, in particular, the state of charge and the aging of the lead acid battery.

If a lead acid battery fails, it may be advantageous to replace it with a lithium ion battery. However, on account of the different technology, a lithium ion battery has different properties to a lead acid battery. These include, inter alia, a lower internal resistance and, in particular, a different relationship between the state of charge and the output voltage. For example, a state of charge, as determined by the battery sensor present in the motor vehicle, would therefore be incorrect.

In the case of replacement, a lithium ion battery would accordingly have to replace not only the conventional lead acid battery but also the battery sensor and the functionality thereof. On account of a high number of variants of the motor vehicles, lead acid batteries and battery sensors available on the market, this does not appear to be feasible.

It is desirable, particularly if a lead acid battery in a motor vehicle fails, to replace said battery with a lithium ion battery. In this case, the battery sensor already present in the motor vehicle should also continue to be used.

US 2015/0037616 A1 discloses a lithium ion battery module, which has a housing whose dimensions correspond to those of a housing of a conventional lead acid battery. The lithium ion battery module in this case also comprises one or more DC voltage converters, as a result of which several different output voltages are available at different poles of the lithium ion battery module.

DE 10 2010 014 104 A1 discloses an electrical energy system for a motor vehicle. The energy system comprises a battery arranged in an electrical subsystem, said battery being coupled to another electrical subsystem by means of a coupling device. In this case, the coupling device comprises two DC voltage converters connected in parallel and a bypass switch for bypassing the DC voltage converters.

### SUMMARY OF THE INVENTION

A battery unit for use in an electrical system of a motor vehicle is proposed. The battery unit comprises a battery module and a coupling unit for coupling the battery module to the electrical system of the motor vehicle. The coupling unit has a first connection connected to the battery module, a second connection that can be connected to the electrical system, a first DC voltage converter and a second DC voltage converter. The battery unit serves, in particular, to replace a failed lead acid battery as a starter battery for an internal combustion engine of the motor vehicle.

According to the invention, the first DC voltage converter permits a bidirectional flow of current between the first connection and the second connection, and the second DC voltage converter permits a flow of current from the first connection to the second connection. The battery unit furthermore comprises a control system for actuating the first DC voltage converter and for actuating the second DC voltage converter.

The coupling unit also preferably has means for measuring a coupling current flowing through the coupling unit between the first connection and the second connection.

The first DC voltage converter is embodied, for example, as a split-pi converter, which has a plurality of electronic switches. By actuating the switches of the first DC voltage converter accordingly, a first voltage can be generated at the first connection and a second voltage can be generated at the second connection. The first DC voltage converter is preferably designed in such a way that a relatively high coupling current can flow in both directions.

The second DC voltage converter is embodied, for example, as a SEPIC converter (single ended primary inductance converter), which has at least one electronic switch. By actuating the at least one switch of the second DC voltage converter accordingly, the second voltage can be generated at the second connection. However, the second DC voltage converter can also be embodied, for example, as a split-pi converter. The second DC voltage converter is preferably designed in such a way that a relatively low power loss is dropped when a relatively low coupling current flows from the first connection to the second connection.

In particular, the two DC voltage converters do not generate a constant second voltage that would be independent of the first voltage. The second voltage applied to the electrical system is dependent on the first voltage applied to the battery module. When actuated accordingly, the DC voltage converters are capable of generating a variable second voltage that is dependent on the first voltage. The dependency of the second voltage on the first voltage is generally not linear.

When actuated accordingly, the first DC voltage converter is also capable of generating a variable first voltage that is dependent on the second voltage. This dependency of the first voltage on the second voltage is generally not linear either.

In accordance with an advantageous refinement of the invention, the battery module of the battery unit has a plurality of battery cells, which are embodied as lithium ion cells. In comparison with cells of lead acid batteries, lithium ion cells have, in particular, an extended service life, an improved cycle stability, a higher energy density and also a higher power density.

In this case, the type of battery cells is not limited to lithium ion cells. In principle, all types of secondary cells that have improved properties in comparison with the lead acid battery cells are suitable. For example, lithium sulfur cells, lithium air cells, supercapacitors (supercaps, SC), lithium capacitors and battery cells with solid electrolytes are suitable.

According to one advantageous development of the invention, the coupling unit has a bypass path, by means of which the first connection and the second connection can be connected to one another so as to bypass the DC voltage converters. The bypass path for this purpose comprises a bypass switch that can be actuated by the control system.

A method for operating a battery unit according to the invention in an electrical system of a motor vehicle is also proposed. In this case, the battery unit is built into the motor vehicle and the second connection of the coupling unit of the battery unit is connected to the electrical system of the motor vehicle.

According to the invention, a coupling current flowing through the coupling unit is measured here. When the coupling current flows from the first connection to the second connection and undershoots a first limit value, the second DC voltage converter is connected and the first DC voltage converter is disconnected. Under these conditions, the motor vehicle is in a quiescent mode. The battery module is discharged and delivers, however, only a relatively low quiescent current, which is lower than the first limit value. The quiescent current flows exclusively through the second DC voltage converter.

When the coupling current flows from the first connection to the second connection and in the process exceeds a first limit value and undershoots a second limit value greater than the first limit value, the first DC voltage converter is connected. In this case, the second DC voltage converter can be disconnected. Under these conditions, the motor vehicle is in a regular mode. The battery module is discharged and delivers an average operating current, which is lower than the second limit value and greater than the first limit value. The operating current flows for the most part or exclusively through the first DC voltage converter.

When the second DC voltage converter is connected, a second voltage is advantageously generated at the second connection by the second DC voltage converter depending on a first voltage at the first connection.

When the coupling current flows from the first connection to the second connection and

the first DC voltage converter is connected, a second voltage is likewise advantageously generated at the second connection by the first DC voltage converter depending on a first voltage at the first connection.

The first voltage at the battery module is dependent, in particular, on the state of charge (SOC) of the battery module. The first voltage can also be dependent on further state variables, among other things on a flowing current and on the aging of the battery module. However, given the same state of charge of a conventional lead acid battery and a battery module comprising lithium ion cells, the first voltage of the lead acid battery deviates from the first voltage of the battery module comprising lithium ion cells.

The second voltage at the electrical system is advantageously generated by the first DC voltage converter and by the second DC voltage converter in such a way that the second voltage at a prescribed state of charge of the battery module corresponds to the first voltage of the lead acid battery at the same state of charge. The second voltage at the electrical system therefore corresponds to the first voltage at the lead acid battery that the lead acid battery would have at the same state of charge.

When the coupling current flows from the second connection to the first connection, the first DC voltage converter is connected. In this case, the second DC voltage converter can be disconnected. Under these conditions, the motor vehicle is in a charging mode. The battery module is charged by way of a charging current. The charging current flows for the most part or exclusively through the first DC voltage converter.

When the coupling current flows from the second connection to the first connection and the first DC voltage converter is connected, a first voltage is advantageously generated at the first connection by the first DC voltage converter depending on a second voltage at the second connection.

When the coupling current flows from the first connection to the second connection and exceeds a second limit value greater than the first limit value, a bypass path for bypassing the DC voltage converters is connected. In this case, the first DC voltage converter and the second DC voltage converter can be disconnected. Under these conditions, the motor vehicle is in a starting mode, for example. The battery module is discharged and delivers a relatively high starting current for a starter, said starting current being greater than the second limit value. The starting current flows for the most part or exclusively through the bypass path.

A battery unit according to the invention and a method according to the invention are advantageously used in an electrical system of a motor vehicle, in particular a motor vehicle having an internal combustion engine. The battery unit according to the invention and the method according to the invention are particularly advantageously used in an electrical system of a motor vehicle having an internal combustion engine, the electrical system and functionalities of which are matched to the properties of a conventional lead acid battery, and in particular serve to replace the lead acid battery. However, other uses, for example in electrical systems of other motor vehicles, for example hybrid vehicles, plug-in hybrid vehicles and electric vehicles, are also conceivable.

The invention makes it possible to replace a conventional 12-V lead acid battery with a 12-V lithium ion battery while ensuring all functionalities, in particular the energy management, in the motor vehicle. A battery sensor that is present in the motor vehicle and is matched to the properties of the replaced lead acid battery can be retained. The coupling unit having the two DC voltage converters therefore makes it possible to use a lithium ion battery in motor vehicles that is matched to the properties of a lead acid battery. By actuating the DC voltage converters accordingly, the first voltage applied to the lithium ion battery can be mapped to a second voltage at the electrical system and at the battery sensor, said first voltage corresponding to the voltage at the lead acid battery under the same conditions, in particular at the same state of charge.

Owing to the design of the coupling unit, said coupling unit can be used in optimum fashion for various types of operation when actuated accordingly. For example, a charging current and an average operating current can thus flow through the first DC voltage converter. A quiescent current can flow through the second DC voltage converter, said quiescent current having a reduced power loss. Therefore, in particular, electrical losses in the coupling unit can be reduced during quiescent mode. The bypass path also makes possible high operating currents, which are not covered by the first DC voltage converter, and also an emergency mode of the coupling unit and the battery unit in the case of a fault or failure of a DC voltage converter.

### BRIEF DESCRIPTION OF THE DRAWINGS

Embodiments of the invention are explained in more detail based on the drawings and the following description.

In said drawings:

FIG. 1 shows a battery unit in an electrical system of a motor vehicle and

FIG. 2 shows a coupling unit of the battery unit of FIG. 1.

### DETAILED DESCRIPTION

In the subsequent description of the embodiments of the invention, identical or similar elements are denoted using identical reference signs, in which case a repeated description of these elements is dispensed with in individual cases. The figures only schematically illustrate the subject matter of the invention.

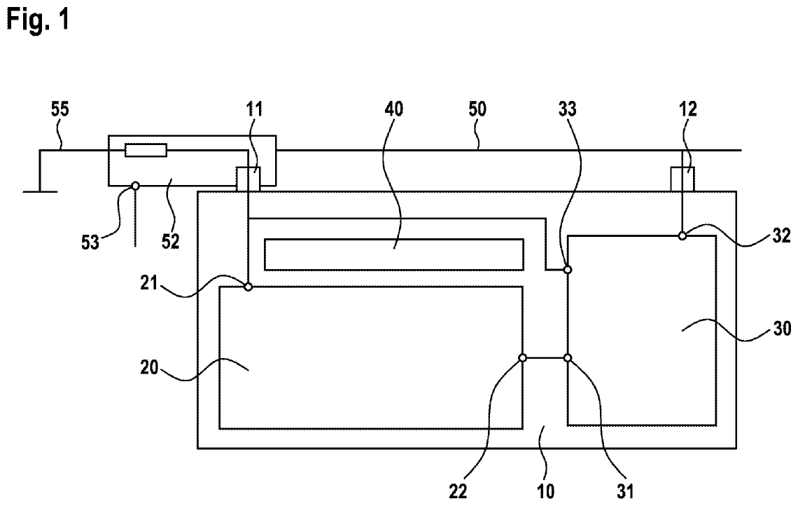

FIG. 1 shows a battery unit 10 in an electrical system 50 of a motor vehicle. In this context, the live supply lines in the motor vehicle are referred to as the electrical system 50. In the present case, the electrical system 50 has a nominal voltage of 12 V with respect to a ground line 55 in the motor vehicle.

The battery unit 10 comprises a battery module 20, which has a plurality of battery cells, which are embodied as lithium ion cells. The battery cells are, for example, connected in series and deliver a nominal voltage of 12 V. The battery module 20 has a negative terminal 21 and a positive terminal 22. The voltage delivered by said battery cells is applied between the terminals 21, 22 of the battery module 20.

The battery unit 10 comprises a positive pole 12, which is connected to the electrical system 50. The battery unit 10 also comprises a negative pole 11, which is connected to a battery sensor 52 and to the negative terminal 21 of the battery module 20. The battery sensor 52 is connected to the electrical system 50 and to the ground line 55. Furthermore, the battery sensor 52 is connected to a superordinate control unit of the motor vehicle by means of a bus interface 53.

The battery sensor 52 measures, inter alia, a voltage applied between the positive pole 12 and the negative pole 11 of the battery unit 10, said voltage corresponding to a voltage between the electrical system 50 and the ground line 55. The battery sensor 52 also measures a current flowing from the ground line 55 to the negative pole 11, said current corresponding to a current through the battery unit 10.

The battery sensor 52 identifies a state, in particular a state of charge, of the battery module 20 of the battery unit 10 from the measured voltage between the poles 11, 12 of the battery unit 10 and from the measured current through the battery unit 10. The battery sensor 52 transmits the identified state of the battery module 20 of the battery unit 10 to the superordinate control unit of the motor vehicle.

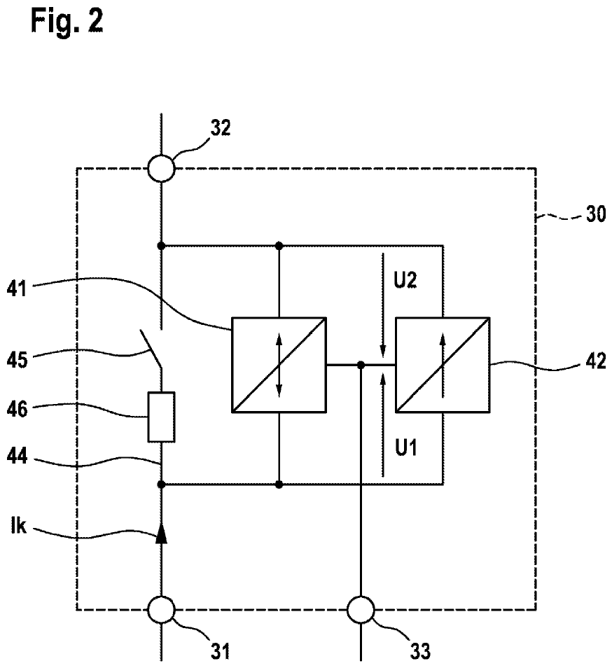

The battery unit 10 further comprises a coupling unit 30, which is illustrated in detail in FIG. 2. Said coupling unit 30 has a first DC voltage converter 41, a second DC voltage converter 42 and a bypass path 44. The coupling unit 30 also has a first connection 31, which is connected to the positive terminal 22 of the battery module 20. The coupling unit 30 additionally has a second connection 32, which is connected to the positive pole 12 of the battery unit 10. The coupling unit 30 furthermore has a ground connection 33, which is connected to the negative pole 11 of the battery unit 10 and to the negative terminal 21 of the battery module 20.

The battery unit 10 furthermore comprises a control system 40, which serves, in particular, to actuate the DC voltage converters 41, 42 and the bypass path 44 of the coupling unit 30. The control system 40 and the coupling unit 30 are connected to one another, for example, by means of a bus line, which is not illustrated here. The battery module 20, the coupling unit 30 and the control system 40 of the battery unit 10 are embodied in the present case as separate elements and arranged as a structural unit in a joint housing. The control system 40, the DC voltage converters 41, 42 and the bypass path 44 could also be combined in one or more units.

FIG. 2 shows the coupling unit 30 of the battery unit 10 illustrated in FIG. 1. A first voltage U1, which corresponds to the voltage of the battery module 20, is applied between the first connection 31 and the ground connection 33. A second voltage U2, which corresponds to the voltage of the electrical system 50, is applied between the second connection 32 and the ground connection 33. A coupling current Ik flows through the coupling unit 30 in the direction from the first connection 31 to the second connection 32. If the coupling current Ik flows in the opposite direction, the coupling current Ik is negative. A current flowing through the ground connection 33 is not taken into account in the following considerations.

The first DC voltage converter 41 and the second DC voltage converter 42 are connected in parallel and are each connected to the first connection 31, the second connection 32 and the ground connection 33. In order to bypass the DC voltage converters 41, 42, a bypass path 44 is provided, which is connected to the first connection 31 and the second connection 32. A bypass switch 45 and a shunt resistor 46 for measuring a current flowing through the bypass path 44 are arranged in the bypass path 44. The shunt resistor 46 may be arranged upstream or downstream of the bypass switch 45. Another type of sensor for current measurement can also be used instead of the shunt resistor 46.

The first DC voltage converter 41 is embodied in the present case as a split-pi converter, which has a plurality of electronic switches, which are not illustrated here. The first DC voltage converter 41 permits a bidirectional flow of current. The first DC voltage converter 41 also permits generation of the first voltage U1 and generation of the second voltage U2. The first voltage U1 and the second voltage U2 can be generated by actuating the switches of the first DC voltage converter 41 accordingly. The first DC voltage converter 41 has means for measuring a current flowing through the first DC voltage converter 41.

The second DC voltage converter 42 is embodied in the present case as a SEPIC converter, which has at least one electronic switch, which is not illustrated here. The second DC voltage converter 42 permits a unidirectional flow of current from the first connection 31 to the second connection 32. The second DC voltage converter 42 also permits generation of the second voltage U2. The second voltage U2 can be generated by actuating the switch or the switches of the second DC voltage converter 42 accordingly. The second DC voltage converter 42 has means for measuring a current flowing through the second DC voltage converter 42.

The bypass switch 45 of the bypass path 44 and the electronic switches of the DC voltage converters 41, 42 can be actuated by the control system 40. Furthermore, the means for current measurement of the DC voltage converters 41, 42 and the shunt resistor 46 of the bypass path 44 are connected to the control system 40.

By measuring the currents flowing through the first DC voltage converter 41, the second DC voltage converter 42 and the bypass path 44, the control system 40 calculates the coupling current Ik. As an alternative thereto, the coupling unit 30 can also have a means, in particular a sensor, for direct measurement of the coupling current Ik. Said sensor may be arranged behind the first connection 31.

A present operating phase of the motor vehicle is identified depending on the magnitude and the direction of the coupling current Ik. The DC voltage converters 41, 42 and the bypass switch 45 are actuated depending on the operating phase of the motor vehicle that is identified.

When the coupling current Ik is negative, the motor vehicle is thus in charging mode and the first DC voltage converter 41 is connected. The second DC voltage converter 42 and the bypass switch 45 are disconnected.

When the coupling current Ik is positive and lower than the first limit value, the motor vehicle is thus in quiescent mode and the second DC voltage converter 42 is connected. The first DC voltage converter 41 and the bypass switch 45 are disconnected.

When the coupling current Ik is positive and greater than the first limit value and lower than the second limit value, the motor vehicle is thus in regular mode and the first DC voltage converter 41 is connected. The second DC voltage converter 42 and the bypass switch 45 are disconnected.

When the coupling current Ik is positive and greater than the second limit value, the motor vehicle is thus in starting mode and the bypass switch 45 is connected. The first DC voltage converter 41 and the second DC voltage converter 42 are disconnected.

The invention is not restricted to the exemplary embodiments described here and to the aspects highlighted therein. Rather, a multiplicity of modifications within the scope of the practice of a person skilled in the art are possible within the scope indicated by the claims.

1. A battery unit (10) of an electrical system (50) of a motor vehicle, the battery unit (10) comprising:
a battery module (20); and
a coupling unit (30) for coupling the battery module (20) to the electrical system (50), the coupling unit (30) having
a first connection (31) connected to the battery module (20),
a second connection (32) connected to the electrical system (50),
a first DC voltage converter (41), and
a second DC voltage converter (42),
wherein
the first DC voltage converter (41) permits a bidirectional flow of current between the first connection (31) and the second connection (32),
the second DC voltage converter (42) permits a flow of current from the first connection (31) to the second connection (32),
and in that
the battery unit (10) comprises a control system (40) for actuating the first DC voltage converter (41) and for actuating the second DC voltage converter (42).

2. The battery unit (10) as claimed in claim 1, characterized in that the battery module (20) has a plurality of battery cells, which are embodied as lithium ion cells.

3. The battery unit (10) as claimed in claim 1, characterized in that
the coupling unit (30) has a bypass path (44), by which the first connection (31) and the second connection (32) are connected so as to bypass the DC voltage converters (41, 42), wherein
the bypass path (44) comprises a bypass switch (45) that is actuated by the control system (40).

4. A method for operating a battery unit (10) as claimed in claim 1 in an electrical system (50) of a motor vehicle, that the method comprising:
measuring a coupling current (Ik) flowing through the coupling unit (30), and
connecting the second DC voltage converter (42) and disconnecting the first DC voltage converter (41)
when the coupling current (Ik) flows from the first connection (31) to the second connection (32) and
undershoots a first limit value.

5. The method as claimed in claim 4, characterized in that
when the coupling current (Ik) flows from the first connection (31) to the second connection (32) and exceeds a first limit value and undershoots a second limit value greater than the first limit value,
the first DC voltage converter (41) is connected.

6. The method as claimed in claim 4, characterized in that
when the second DC voltage converter (42) is connected, a second voltage (U2) is generated at the second connection (32) by the second DC voltage converter (42) depending on a first voltage (U1) at the first connection (31).

7. The method as claimed in claim 4, characterized in that
when the coupling current (Ik) flows from the first connection (31) to the second connection (32) and
the first DC voltage converter (41) is connected,
a second voltage (U2) is generated at the second connection (32) by the first DC voltage converter (41) depending on a first voltage (U1) at the first connection (31).

8. The method as claimed in claim 4, characterized in that
when the coupling current (Ik) flows from the second connection (32) to the first connection (31),
the first DC voltage converter (41) is connected.

9. The method as claimed in claim 4, characterized in that
when the coupling current (Ik) flows from the second connection (32) to the first connection (31) and
the first DC voltage converter (41) is connected,
a first voltage (U1) is generated at the first connection (31) by the first DC voltage converter (41) depending on a second voltage (U2) at the second connection (32).

10. The method as claimed in claim 4, characterized in that
when the coupling current (Ik) flows from the first connection (31) to the second connection (32) and exceeds a second limit value greater than the first limit value,
a bypass path (44) for bypassing the DC voltage converters (41, 42) is connected.

11. The battery unit (10) as claimed in claim 1 wherein the electrical system (50) and functionalities of which are matched to the properties of a lead acid battery.

12. The method as claimed in claim 4, wherein the electrical system (50) and functionalities of which are matched to the properties of a lead acid battery.

13. The battery unit (10) as claimed in claim 1, wherein the motor vehicle has an internal combustion engine.

14. The method as claimed in one of claim 4, wherein the motor vehicle has an internal combustion engine.
